(19) United States
(12) Patent Application Publication
(10) Pub. No.: US 2013/0073685 A1
(43) Pub. Date: Mar. 21, 2013

(54) SYSTEMS AND METHODS FOR RECEIVER-CONTROLLED DATA DISTRIBUTION

(71) Applicants: Gonzalo Isaza, Redmond, WA (US); Carlos Alberto Isaza, Oakville (CA)

(72) Inventors: Gonzalo Isaza, Redmond, WA (US); Carlos Alberto Isaza, Oakville (CA)

(73) Assignee: IBROMED CORPORATION, Redmond, WA (US)

(21) Appl. No.: 13/233,889

(22) Filed: Sep. 15, 2011

(51) Int. Cl. G06F 15/16

(52) U.S. Cl. 709/219

(57) ABSTRACT

Systems and methods for receiver-controlled data distribution are provided. In some embodiments, a client device requests and receives a session locator code. This session locator code is then used by a set of users of other client devices in the session to exchange data objects or documents. In some embodiments, the session locator code is invalidated when no client devices are using the session locator code to share data. In some embodiments, permanent locator codes may be used. A permanent locator code may allow a user to make data available whether or not any client devices are currently using the permanent locator code to access the data.

### BACKGROUND

With the growing ubiquity of networked computing devices, users have a growing need to transmit data between these devices. For example, in a meeting or conference, each attendee may bring one or more devices with them that are connected to a network and capable of storing and transmitting data. While there are existing technologies that allow transfer of data between devices, the existing technologies may be unduly cumbersome to activate and configure, or may require a receiving user to disclose more identifying information to a sending user than is desirable. What is needed is a way to securely transfer data objects or documents between computing devices that is controlled by a user of the receiving device, and that allows the user of the receiving device to maintain an adequate level of privacy

### SUMMARY

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

In one embodiment, a computer-implemented method of exchanging data is provided. A first device receives a locator code. At least the first device uploads one or more data objects to a server device to be associated with the locator code, and at least a second device retrieves the one or more data objects from the server device by using the locator code.

In another embodiment, a computer-implemented method for managing a locator code is provided. A request is received from a requesting device for a new locator code. A locator code not currently in use is assigned as the new locator code. The new locator code is transmitted to the requesting device. One or more data objects to be associated with the new locator code are received. The one or more data objects are stored in a document data store, and the stored data objects are associated with the new locator code.

### DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIG. 1 illustrates an overview of an exemplary embodiment of a data distribution system according to various aspects of the present disclosure;

FIG. 2 is a block diagram that illustrates further details of an exemplary embodiment of a client device and an exemplary embodiment of a server device according to various aspects of the present disclosure;

FIGS. 3A-3G illustrate an exemplary embodiment of a method of exchanging data between computing devices according to various aspects of the present disclosure;

FIG. 4 illustrates an exemplary embodiment of a procedure in which a session locator code distribution engine generates a session locator code and stores a record of the session locator code generation in a session locator code data store, according to various aspects of the present disclosure;

FIG. 5 illustrates an exemplary embodiment of a client device such as a smart phone and/or the like presenting an interface for requesting a session locator code, according to various aspects of the present disclosure;

FIG. 6 illustrates a client device presenting an exemplary interface for presenting a received session locator code to a requesting user, according to various aspects of the present disclosure;

FIG. 7 illustrates a client device presenting an exemplary interface for receiving manual entry of a session locator code obtained by a different client device, according to various aspects of the present disclosure;

FIG. 8 illustrates a client device 502 presenting an exemplary interface for exchanging documents according to various aspects of the present disclosure;

FIG. 9 illustrates one embodiment of a method 900 of exchanging data using a permanent locator code according to various aspects of the present disclosure; and

FIG. 10 illustrates aspects of an exemplary computing device 1000 appropriate for use with embodiments of the present disclosure.

### DETAILED DESCRIPTION

Embodiments of the present disclosure provide systems and methods for simple distribution of data objects and documents from one or more uploading devices to one or more downloading devices. An uploading device obtains a code from a server device that allows a device to locate a sharing session. This locator code may be used by the one or more uploading devices to upload data objects or documents to the sharing session, and may be used by the one or more downloading devices to download the uploaded data objects or documents. The server device may prevent access to the uploaded data objects or documents if a requesting device does not provide the locator code, thereby providing security for the documents. The downloading devices may simply need to obtain the locator code to download the data objects or documents, and are not required to share contact information or other personally identifying information with the uploading device, the uploading user, or the server device. Hence, the transmission of documents is controlled by the user of the downloading device, and the user of the downloading device can feel safe in downloading the documents or data objects without running the risk of receiving subsequent unsolicited communications from the uploading party.

In some embodiments, both session locator codes and permanent locator codes are supported. In an exemplary embodiment, a session locator code may be generated upon receipt of a request from a client device, and the session locator code may thereafter be used to distribute data objects. When all client devices have stopped using the session locator code, the session locator code may be disabled for future data distribution and any uploaded data objects or documents may be deleted from the server device. In an exemplary embodiment, a permanent locator code may be requested by a user, and assigned to the user by the server device if it has not been previously assigned. The permanent locator code may remain enabled regardless of whether any client devices are actively using the permanent locator code to obtain data objects.

Throughout this specification, the sharing, transmission, and storage of “documents” and “data objects” are discussed. A “data object” may be any type of computer-readable data, including a “document.” In some embodiments, “data objects” and “documents” may have different characteristics, or may be treated differently by the system. For example, in some embodiments, documents are common storage files that may be generated by components outside of the system disclosed herein, such as a plain text document, a document created in a word processing program, an image file, a PDF file, and/or the like. In some embodiments, data objects may be created within the system disclosed herein, and may provide data adapted for editing and/or display within the present system. Data objects may include other data objects, and may even include entire documents. In some embodiments, documents and data objects may be used within the system to provide a structured way to exchange coupons, business cards, images, and/or the like. In some embodiments, documents and/or data objects that are not explicitly supported by the system may nevertheless be exchanged between client devices, and may be provided to a user of a downloading client device via an external communication channel, such as via email and/or the like.

It should be noted that these descriptions of documents and data objects are exemplary only, and that any suitable document or data object may be exchanged between client devices using embodiments of the system described herein. It should further be noted that, in the discussion below, the term “document” and the term “data object” may be used interchangeably, but only one of the two terms may be used in certain cases to improve the clarity of the description. One of ordinary skill in the art will recognize that, unless otherwise noted, discussion below relating to “documents” relates to “data objects” as well, and discussion below relating to “data objects” also relates to “documents.”

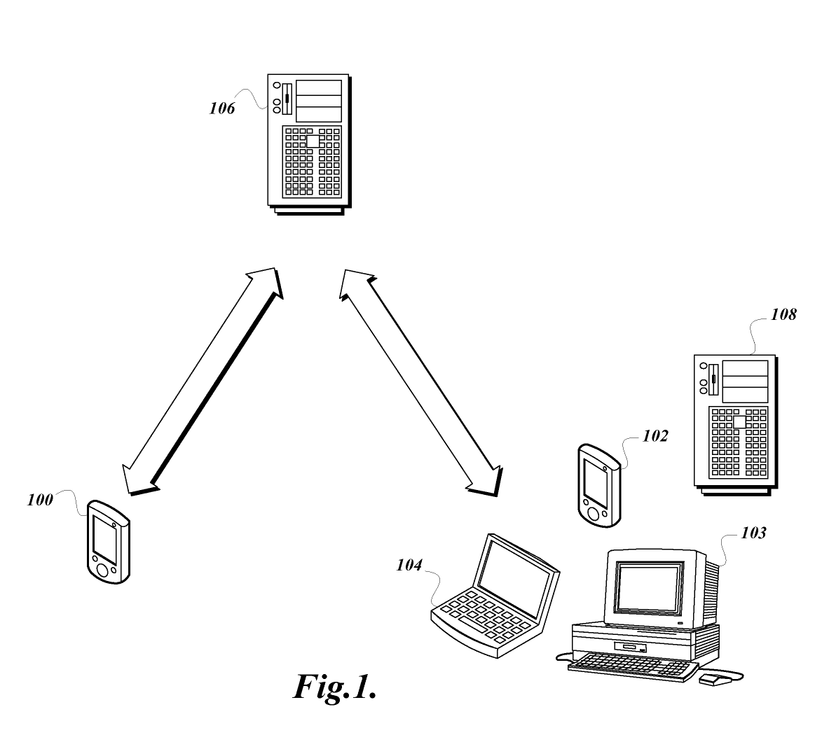

FIG. 1 illustrates an overview of an exemplary embodiment of a data distribution system according to various aspects of the present disclosure. In its simplest form, an uploading client device 100 initiates a session with a locator code server device 106. The locator code server device 106 generates a session locator code for use in locating the session. The uploading client device 100 shares documents using the session locator code, and shares the session locator code with one or more downloading devices, such as a downloading mobile device 102 used by another meeting or conference attendee or the like. This example of a downloading device is exemplary only, as any type of downloading device, such as a downloading desktop computer 103, a downloading laptop computer 104, a downloading server device 108, and/or the like, may also be used. Further, the use of only one uploading client device 100 to upload documents in association with the session locator code is exemplary only. In some embodiments, multiple uploading devices may share documents using the session locator code.

In some embodiments, the locator code server device 106 may generate both session locator codes and permanent locator codes. For session locator codes, the locator code server device 106 may track a number of devices participating in a session, and may invalidate the session locator code and delete documents associated with the session locator code from the locator code server device 106 once no more devices are participating in the session. For permanent locator codes, the locator code server device 106 may maintain the availability of the associated documents regardless of whether any downloading devices are currently using the locator code.

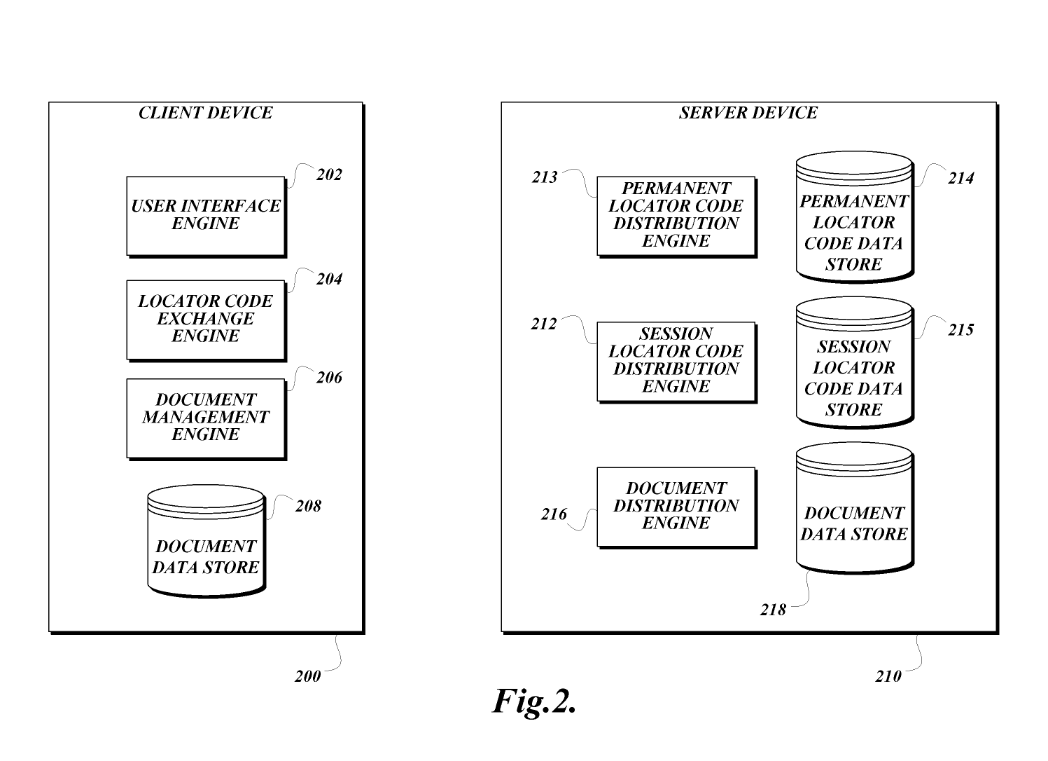

FIG. 2 is a block diagram that illustrates further details of an exemplary embodiment of a client device 200 and an exemplary embodiment of a server device 210 according to various aspects of the present disclosure. Any of the client devices 100, 102, 103, 104 illustrated in FIG. 1 may include components similar to those illustrated in client device 200, and the locator code server device 106 illustrated in FIG. 1 may include components similar to those illustrated in server device 210. Both the client device 200 and the server device 210 may be any suitable computing device.

Along with the general components of a computing device as described below, the illustrated client device 200 includes a user interface engine 202, a locator code exchange engine 204, a document management engine 206, and a document data store 208. The user interface engine 202 may cause various graphical, audio, and/or tactile information to be presented to a user of the client device 200 via one or more output devices, and accepts input from the user via one or more input devices. The input devices and the output devices may overlap, such as in a touch screen and/or the like, or may be separate devices, such as in a keyboard which is capable only of input, or as in a loudspeaker which is capable only of output. Some examples of various information that is caused to be presented by the user interface engine 202 are discussed further below.

The locator code exchange engine 204 may perform actions including sending requests for locator codes to a server device 210. The locator code exchange engine 204 may also receive locator codes for use from the user interface engine 202 that were previously generated or requested. The document management engine 206 may manage documents stored within a document data store 208. The document management engine 206 may provide access to documents within the document data store 208 for listing by the user interface engine 202, and may then upload documents from the document data store 208 to a server device 210 for distribution in association with a given locator code. The document management engine 206 may also receive documents or a list of documents associated with a locator code from a server device 210, and may then store received documents in the document data store 208.

Along with the general components of a computing device as described below, the illustrated server device 210 includes a permanent locator code distribution engine 213, a session locator code distribution engine 212, a document distribution engine 216, a permanent locator code data store 214, a session locator code data store 215, and a document data store 218. The permanent locator code distribution engine 213 may check to see if requested permanent locator codes are available, and if so, may assign the requested permanent locator codes to requesting users and store a record of the assignment in the permanent locator code data store 214. The permanent locator code distribution engine 213 may also validate document requests that are associated with submitted permanent locator codes, and may instruct the document distribution engine 216 to provide documents or document lists associated with such requests, when valid.

The session locator code distribution engine 212 may generate session locator codes in response to requests from clients, and may store the generated session locator codes in the session locator code data store 215. The session locator code distribution engine 212 may also validate requests to store or retrieve documents associated with the generated session locator codes. The document distribution engine 216 may transmit documents or document lists associated with locator codes in response to valid document retrieval requests, and may store documents associated with locator codes in response to valid document storage requests. Further details of the functionality of the components of the server device 210 are described below.

In some embodiments, the permanent locator code distribution engine 213, the session locator code distribution engine 212, and the document distribution engine 216 may provide one or more user interfaces, such as a web-based interface, through which functionality may be accessed through a standard web browser. In some embodiments, the permanent locator code distribution engine 213, the session locator code distribution engine 212, and the document distribution engine 216 may provide application programming interfaces (APIs), such as web services APIs and/or the like, for programmatic access to component functionality.

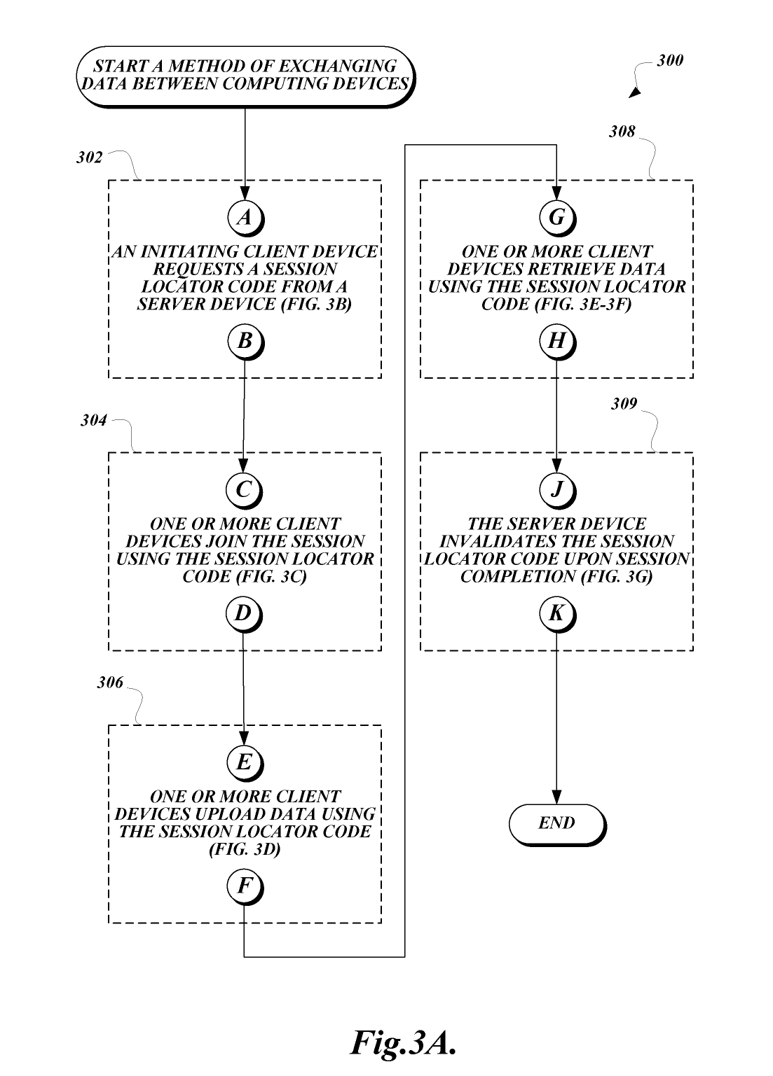

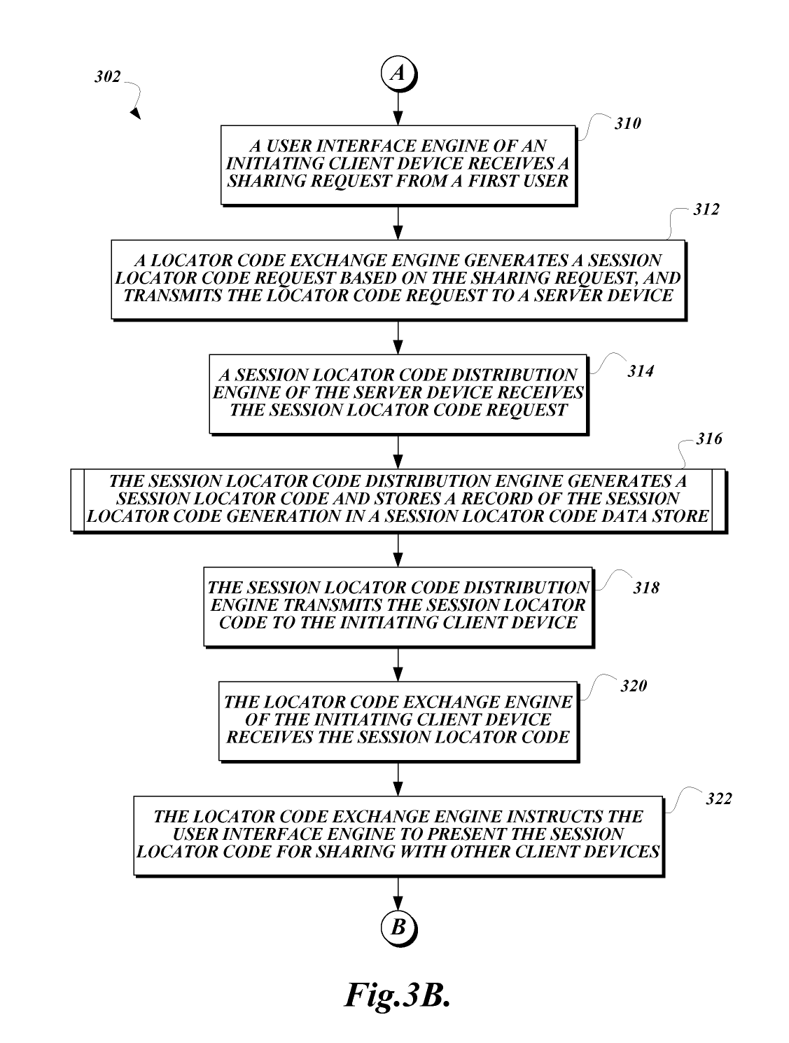

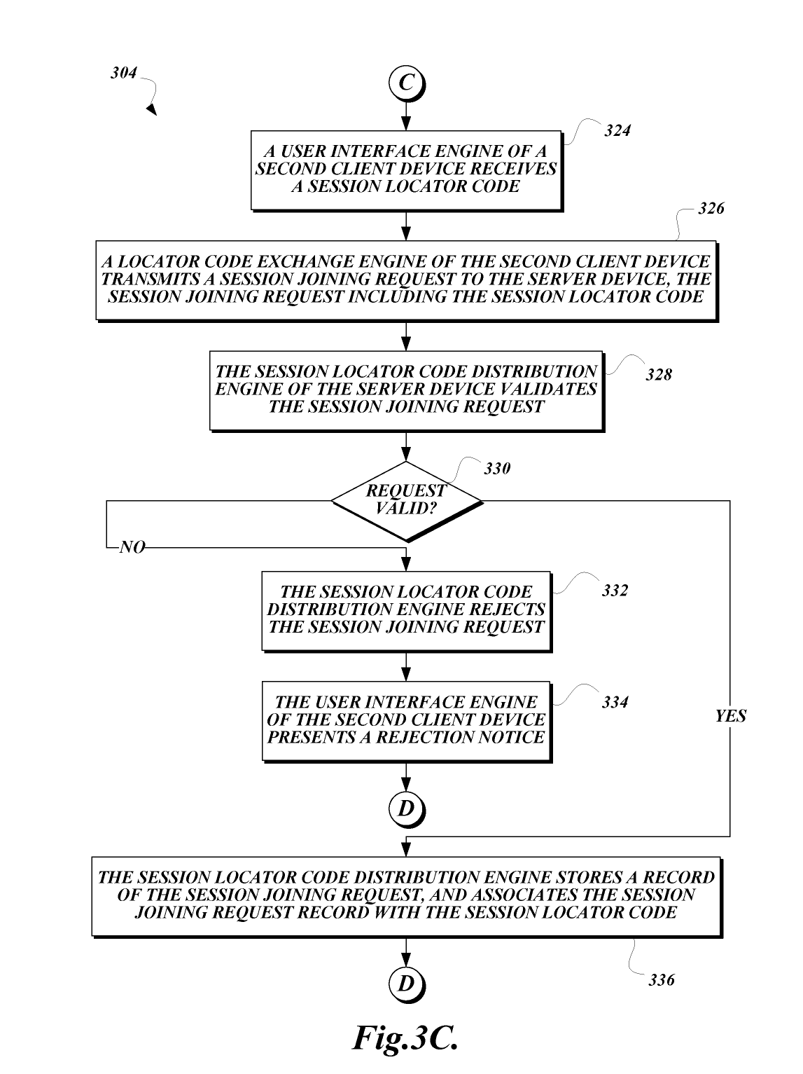

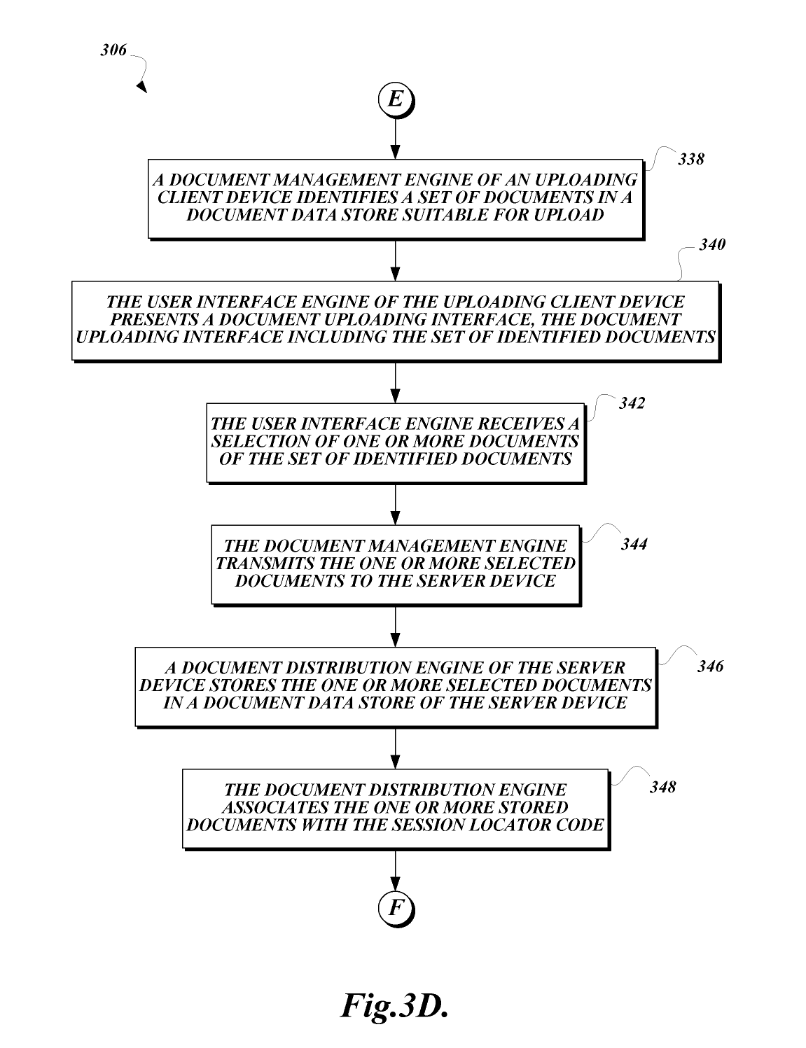

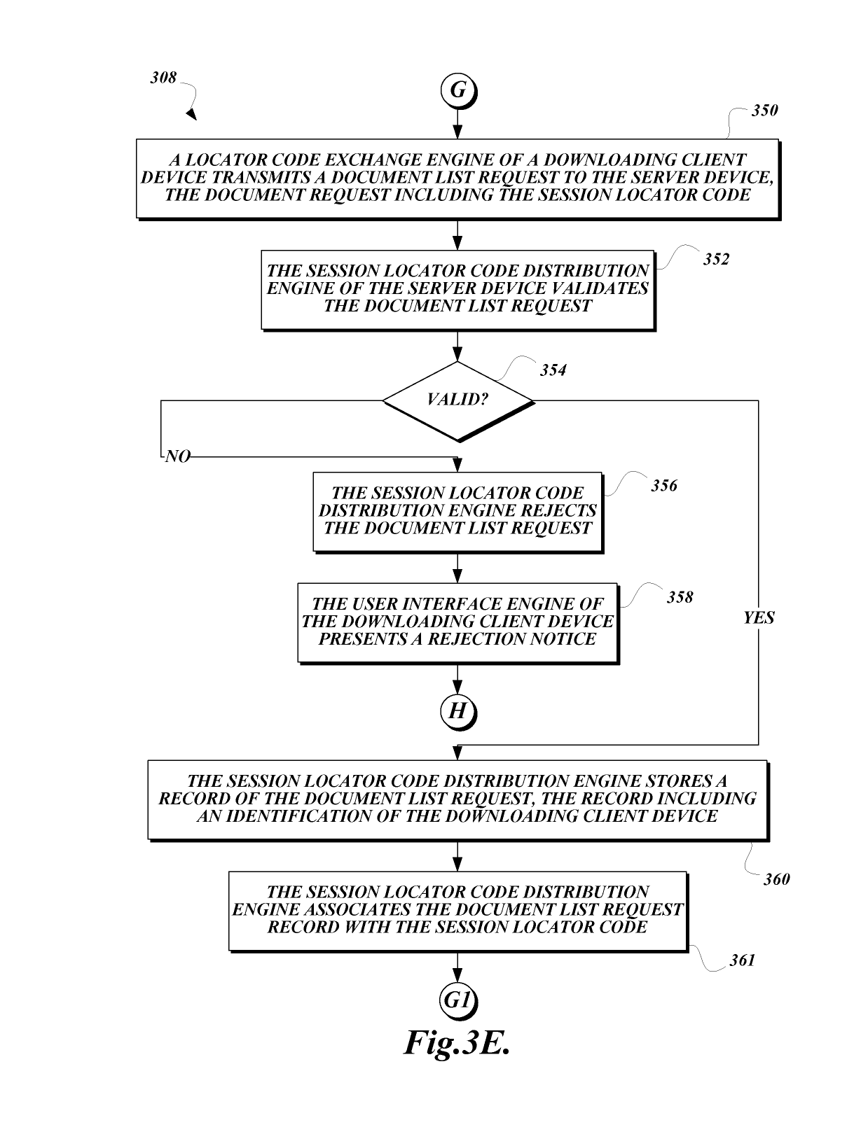

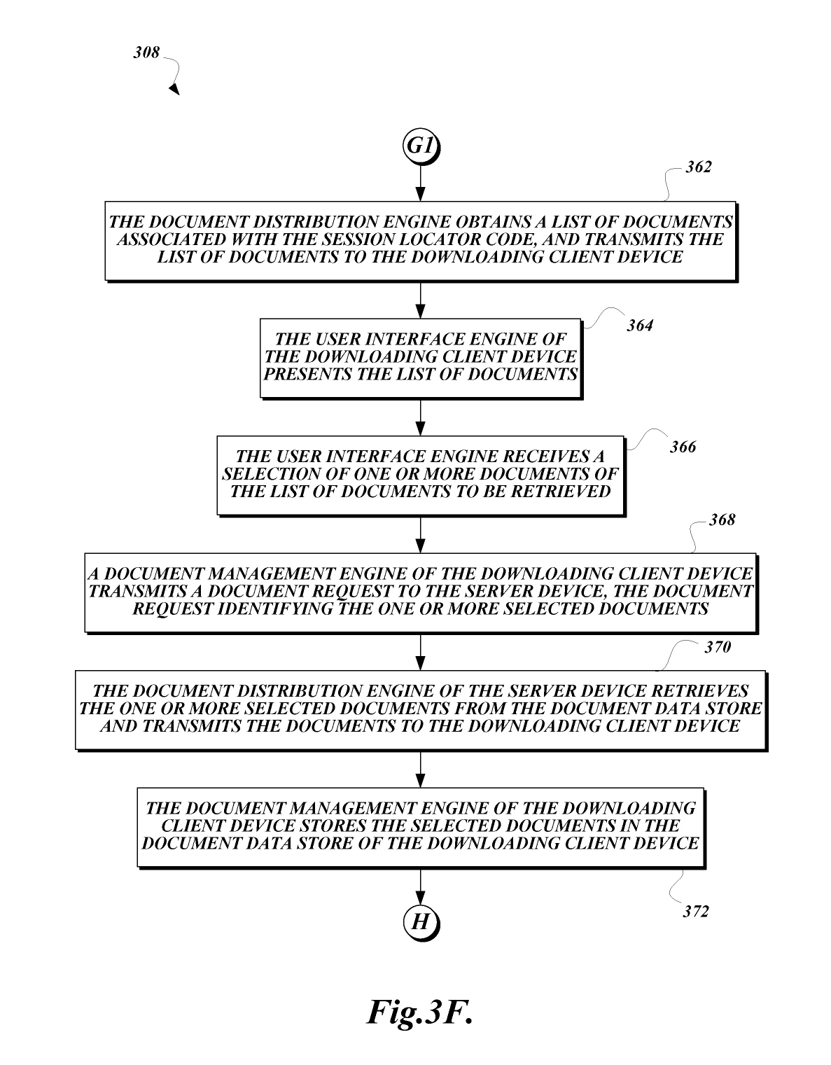

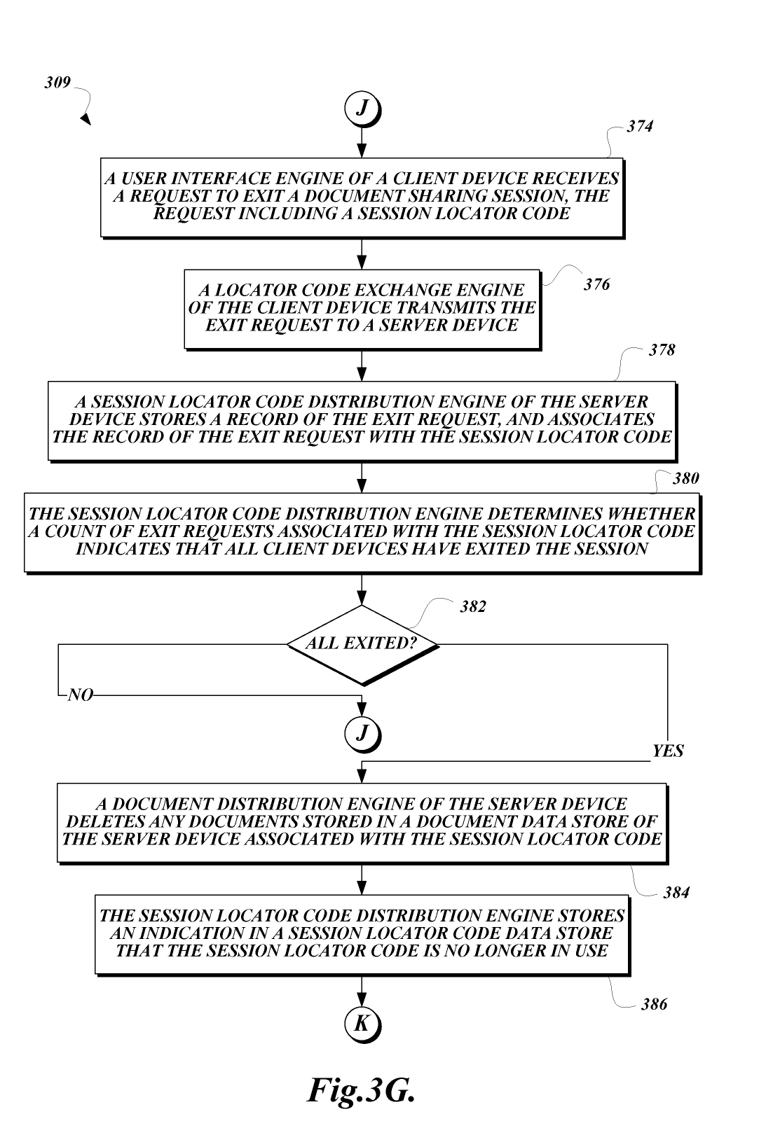

FIGS. 3A-3G illustrate an exemplary embodiment of a method 300 of exchanging data between computing devices according to various aspects of the present disclosure.

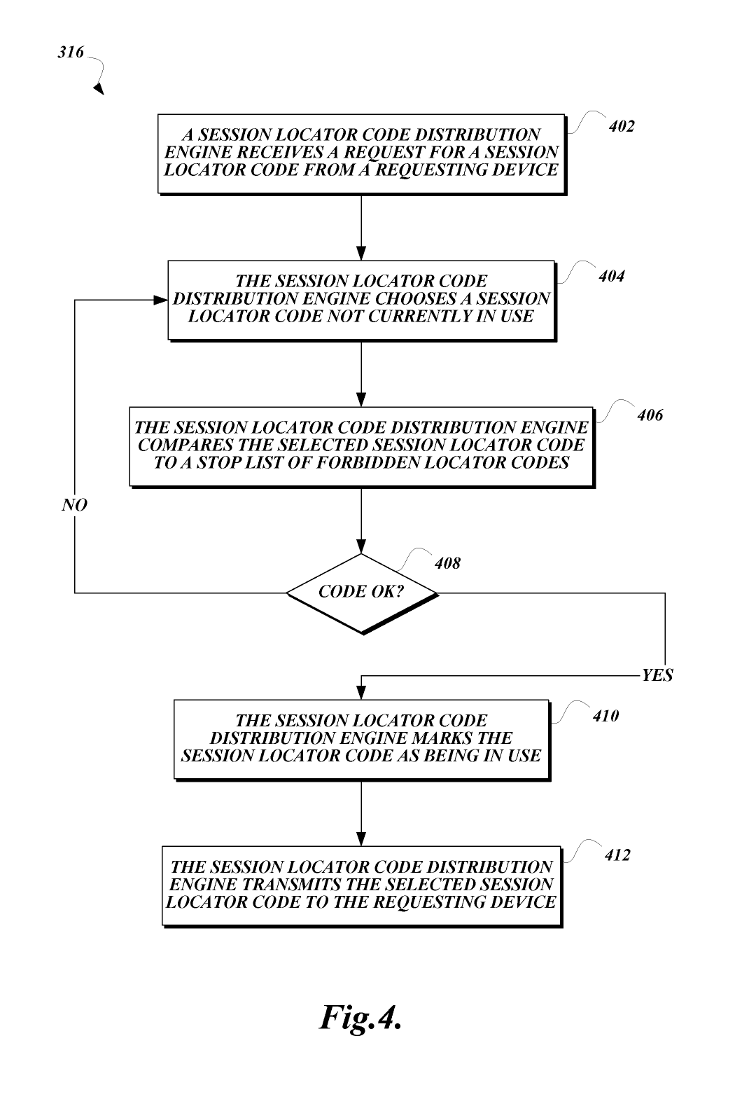

From a start block (FIG. 3A), the method 300 proceeds to a set of method steps 302 between a first continuation terminal (“terminal A”) and a second continuation terminal (“terminal B”), wherein an initiating client device requests a session locator code from a server device. From terminal A (FIG. 3B), the method 300 proceeds to block 310, where a user interface engine 202 of an initiating client device receives a file sharing request from a first user. Next, at block 312, a locator code exchange engine 204 generates a session locator code request based on the sharing request, and transmits the locator code request to a server device 210. The method 300 then proceeds to procedure block 314, where a session locator code distribution engine 212 of the server device 210 generates a session locator code, and stores a record of the session locator code generation in a session locator code data store 215. Session locator codes may be generated by any suitable method, and an exemplary procedure for doing so is described further with respect to FIG. 4.

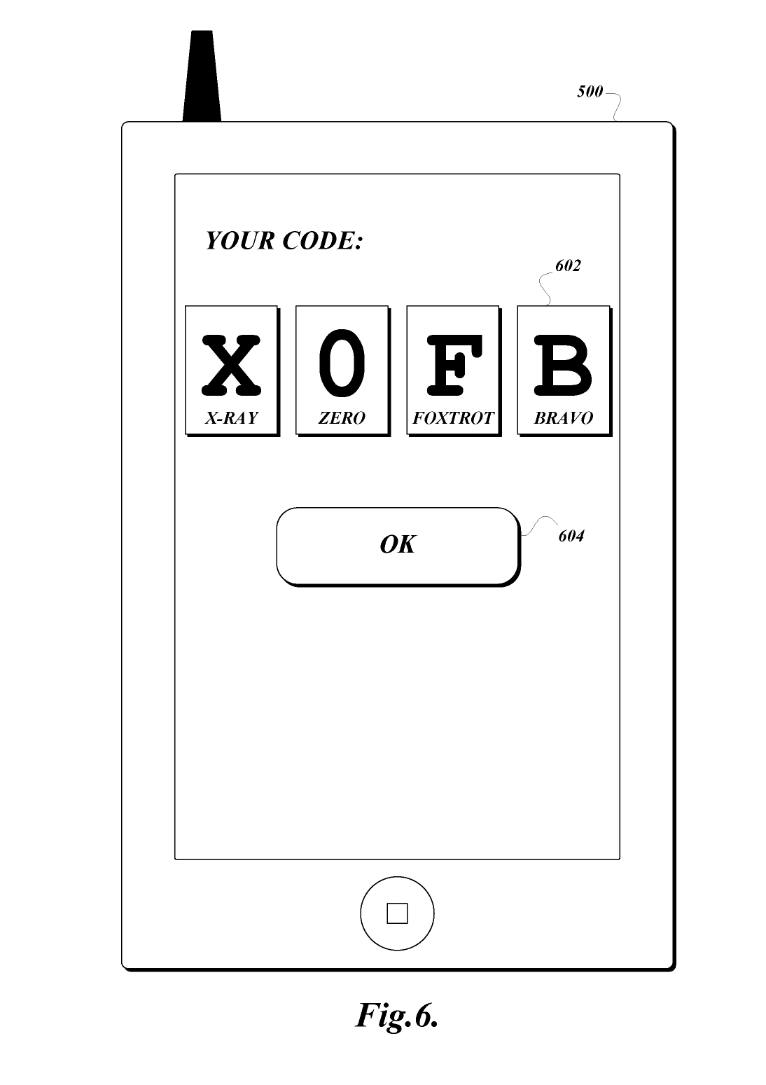

Once a session locator code is generated, the method 300 proceeds to block 318, where the session locator code distribution engine 212 transmits the session locator code to the initiating client device. At block 320, the locator code exchange engine 204 of the initiating client device receives the session locator code. Next, at block 322, the locator code exchange engine 204 instructs the user interface engine 202 to present the session locator code for sharing with other client devices. One example of an interface suitable for presenting the session locator code for sharing with other client devices is illustrated in FIG. 6, and is described further below. In this example, the session locator code may be verbally or visually shared by a user of the initiating client device, and may be manually input into one or more other client devices to join the session. The verbal sharing of the session locator code paired with manual input may have advantages that include ease, reliability, and speed of sharing the session locator code in comparison to other techniques. In another example, an interface may encode and present the session locator code as a bar code such as a QR-code and/or the like, and the session locator code may be entered into one or more other client devices by decoding a captured representation of the bar code. In still other examples, other interface techniques such as near-field communication, infra-red data communication, Bluetooth, and/or the like may be used to present the session locator code for sharing with other client devices. The method 300 then proceeds to a continuation terminal (“terminal B”).

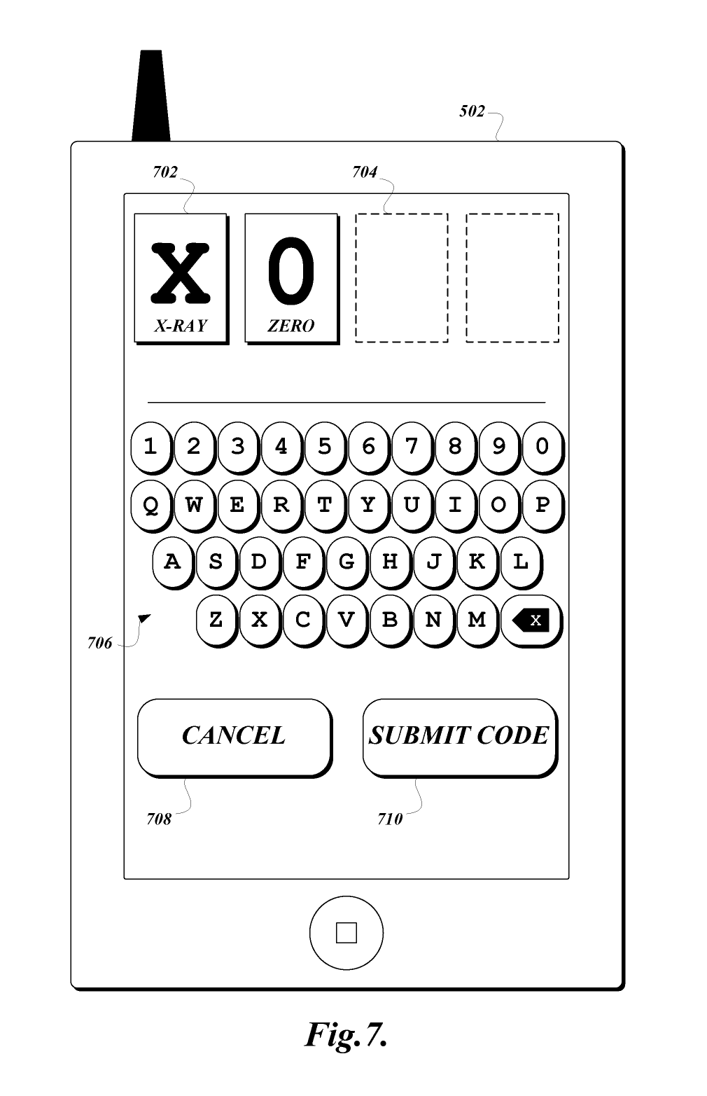

From terminal B (FIG. 3A), the method 300 proceeds to a set of method steps defined between a first continuation terminal (“terminal C”) and a second continuation terminal (“terminal D”), wherein one or more client devices join the session using the session locator code. From terminal C (FIG. 3C), the method 300 proceeds to block 324, where a user interface engine 202 of a second client device receives a session locator code. The second client device may receive the session locator code by any of the techniques discussed above with regard to presenting the session locator code for sharing. One example of a suitable interface by which the second client device may receive the session locator code via user input is illustrated in FIG. 7 and is discussed further below.

The second client device may be, for example, a client device used by another participant in a meeting attended by a user of the initiating client device, where the users of the two client devices are attempting to share documents between the client devices. Though the method 300 is primarily described herein in relation to a single “second client device,” this is for ease of discussion only. In other embodiments, one or more client devices may each perform the steps described herein in relation to the second client device, such that documents may be shared to and from one or more client devices.

At block 326, a locator code exchange engine 204 of the second client device transmits a session joining request to the server device 210, the session joining request including the session locator code. Next, at block 328, the session locator code distribution engine 212 of the server device 210 validates the session joining request. In some embodiments, the validation may include checking to see if a record in the session locator code data store 215 indicates that the submitted session locator code is valid and/or assigned. In some embodiments, the validation may include checking to see how many other session joining requests have been received in association with the session locator code, and comparing the number of received session joining requests to a threshold. At decision block 330, a test is performed to determine whether the session joining request was found to be valid.

If the answer to the test at decision block 330 is NO, the method 300 proceeds to block 332, where the session locator code distribution engine 212 rejects the session joining request. In some embodiments, this rejection may include transmitting a notification to the locator code exchange engine 204 of the second client device that the session joining request was rejected. Next, in block 334, the user interface engine 202 of the second client device presents a rejection notice to the user. The method 300 then proceeds to a continuation terminal (“terminal D”). At this point, if the second client device wishes to join a session, it will have to perform the set of method steps 304 again.

If the answer to the test at decision block 330 is YES, the method 300 proceeds to block 336, where the session locator code distribution engine 212 stores a record of the session joining request, and associates the session joining request record with the session locator code. The record of the session joining request may contain an identification of the second client device, and/or may contain an identification of a user of the second client device. The record of the session joining request and the association between the session joining request record and the session locator code may be stored in the session locator code data store 215. The session locator code distribution engine 212 may also transmit a success notification to the second client device. The method 300 then proceeds to a continuation terminal (“terminal D”).

From terminal D (FIG. 3A), the method 300 proceeds to a set of method steps 306 defined between a first continuation terminal (“terminal E”) and a second continuation terminal (“terminal F”), wherein one or more client devices upload data using the session locator code. From terminal E (FIG. 3D), the method 300 proceeds to block 338, where a document management engine 206 of an uploading client device identifies a set of documents in a document data store suitable for upload. The uploading client device may be a client device that has previously performed the set of method steps 304 to join the session, such as the second client device. More than one uploading client device may be associated with a single session, but only a single uploading client device is described for ease of discussion.

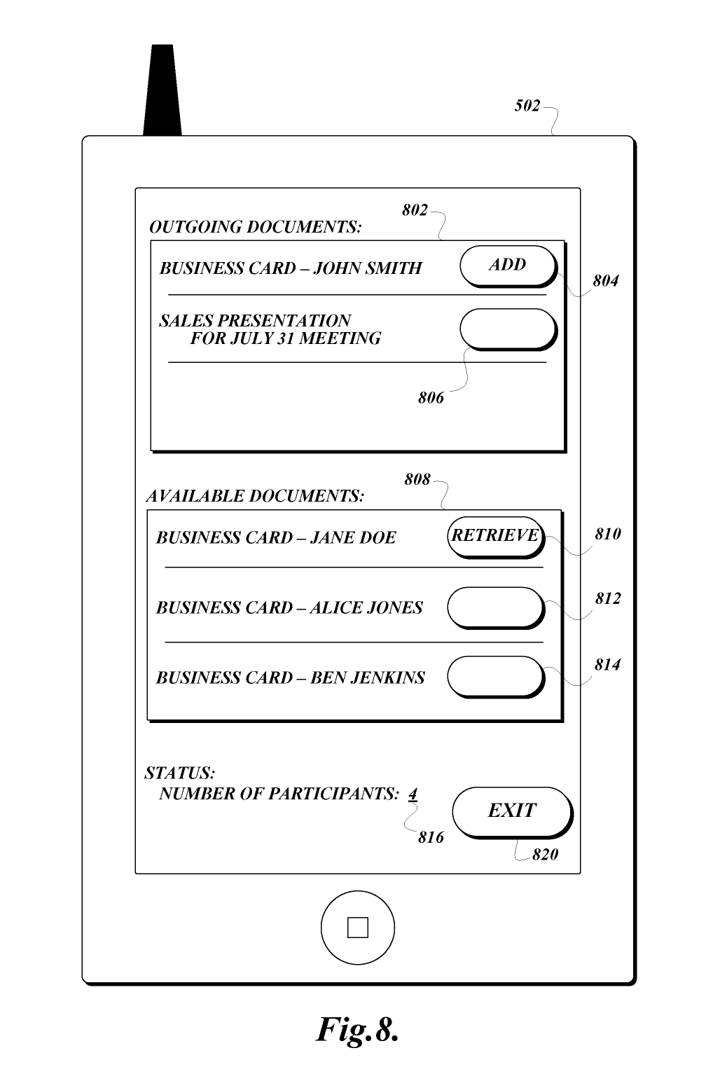

Next, at block 340, the user interface engine 202 of the uploading client device presents a document uploading interface, the document uploading interface including the set of identified documents. The document uploading interface displays the set of identified documents, and allows a user of the uploading client device to select which of the documents to share with other participants in the session. For example, the document management engine 206 may have identified multiple presentation documents stored in the document data store 208, and the user may select which of the presentation documents are appropriate to share in a particular session. One example of a suitable document uploading interface is illustrated in FIG. 8 and is described further below.

At block 342, the user interface engine 202 receives a selection of one or more documents of the set of identified documents. Next, at block 344, the document management engine 206 transmits the one or more selected documents to the server device 210. The method 300 then proceeds to block 346, where a document distribution engine 216 of the server device 210 stores the one or more selected documents in a document data store 208 of the server device 210, and to block 348, where the document distribution engine 216 associates the one or more stored documents with the session locator code. In some embodiments, the document distribution engine 216 may perform actions to improve efficiency, performance, or security. For example, if the document distribution engine 216 detects that one of the selected documents is already stored in the document data store 218, the document distribution engine 216 may not store an additional copy of the document, but may instead simply associate the existing copy of the stored document with the session locator code. As another example, the document distribution engine 216 may compress or encrypt the one or more selected documents before storage.

At this point, the server device 210 has stored copies of the one or more selected documents, and is ready to provide them in response to requests from client devices that are participating in the session. The method 300 then proceeds to a continuation terminal (“terminal F”). From terminal F (FIG. 3A), the method 300 proceeds to a set of method steps 308 defined between a first continuation terminal (“terminal G”) and a second continuation terminal (“terminal H”), wherein one or more client devices retrieve data using the session locator code. From terminal G (FIG. 3E), the method 300 proceeds to block 350, where a locator code exchange engine 204 of a downloading client device transmits a document list request to the server device 210, the document request including the session locator code. As with the other portions of the method 300 described above, one or more downloading client devices may perform the set of method steps 308 concurrently or sequentially. The below description refers to a single downloading client device for ease of discussion only, and does not exclude multiple downloading client devices from performing the described actions. Further, the downloading client device may be the same device as the initiating client device, the second client device, and/or the uploading client device described above. As such, the downloading client device may have requested the session locator code, may have received the session locator code from another client device, and/or may have already uploaded documents associated with the session locator code.

Next, the session locator code distribution engine 212 of the server device 210 validates the document list request. To this end, the document list request may include at least an identification of the downloading client device, an identification of a user associated with the downloading client device, and/or the session locator code. The session locator code distribution engine 212 may validate the document list request by determining whether the downloading client device had previously joined the session, such as by executing the set of method steps 304 described above (or a similar set of method steps). In some embodiments, the session locator code distribution engine 212 may not require that the downloading client device had previously joined the session, but may instead validate the document list request and perform steps such as the set of method steps 304 to join the downloading client device to the session concurrently.

In decision block 354, a test is performed to determine whether the document list request was determined to be valid. If the answer to the test at decision block 354 is NO, then the method 300 proceeds to block 356, where the session locator code distribution engine 212 rejects the document list request, and to block 358, where the user interface engine 202 of the downloading client device presents a rejection notice to the user. In some embodiments, the document list request may be found to be invalid because a session locator code included in the request is determined to be unassigned, because the downloading client device is not authorized to access the session, because the user is not authorized to access the session, and/or the like. From block 358, the method 300 proceeds to a continuation terminal (“terminal H”). At this point, if the user of the downloading client device wishes to successfully download documents associated with the session, the set of method steps 308 will have to be performed again.

If the answer to the test at decision block 356 is YES, then the method proceeds to block 360, where the session locator code distribution engine 212 stores a record of the document list request, the record including an identification of the downloading client device. Next, at block 361, the session locator code distribution engine 212 associates the document list request record with the session locator code. In some embodiments, these records may be stored in the session locator code data store 215. The records may be used to track a number of downloading client devices that are currently active as part of the session, in order to determine when no downloading client devices remain active in the session. From block 361, the method 300 proceeds to a continuation terminal (“terminal G1”).

From terminal G1 (FIG. 3F), the method 300 proceeds to block 362, where the document distribution engine 216 obtains a list of documents associated with the session locator code, and transmits the list of documents to the downloading client device. Next, at block 364, the user interface engine 202 of the downloading client device presents the list of documents. One exemplary embodiment of an interface that may be presented by the user interface engine 202 to present the list of documents is illustrated in FIG. 8 and described further below. In some embodiments, the list of documents transmitted to the downloading client device may include, for each document, an identification of a client device that uploaded the document. In these embodiments, the user interface engine 202 of the downloading client device may identify which of the listed documents were uploaded by the downloading client device, and may hide them from the presented document list to reduce visual clutter. In other embodiments, the document distribution engine 216 may use the identification of the downloading client device submitted with the document list request to filter out documents uploaded by the downloading client device, and may transmit a list of documents to the downloading client device that does not include documents uploaded by the downloading client device.

Next, at block 366, the user interface engine 202 receives a selection of one or more documents of the list of documents to be retrieved. The method 300 then proceeds to block 368, where a document management engine 206 of the downloading client device transmits a document request to the server device 210, the document request identifying the one or more selected documents. The documents may be identified using any suitable technique, such as by a file name, by a unique file identifier, by a position in the list of documents, and/or the like. At block 370, the document distribution engine 216 of the server device 210 retrieves the one or more selected documents from the document data store 218 and transmits the documents to the downloading client device. Next, at block 372, the document management engine 206 of the downloading client device stores the selected documents in the document data store 208 of the downloading client device. The downloaded documents may then be presented to the user, or may remain stored for later use. The method 300 then proceeds to a continuation terminal (“terminal H”).

In some embodiments, the functionality discussed above relating to obtaining the list of documents may be optional. That is, instead of requesting a list of documents, the downloading client device may request that all documents associated with the session locator code be downloaded, thereby eliminating the need for selecting documents for download from a document list. This may be particularly appropriate in cases where many small documents are associated with the session locator code. In such an embodiment, the document distribution engine 216 may still filter the documents transmitted to the downloading client device, and may not transmit documents that were uploaded by the downloading client device.

From terminal H (FIG. 3A), the method 300 proceeds to a set of method steps 309 defined between a first continuation terminal (“terminal J”) and a second continuation terminal (“terminal K”), wherein the server device 210 invalidates the session locator code upon session completion. One of the characteristics of a session locator code is that a given session locator code is only valid for the duration of a session. Once the session is completed, the documents that were previously uploaded in association with the session locator code will no longer be obtainable from the server device 210 via the session locator code. Among other effects, this provides a level of security for the documents shared within the session. Another effect of invalidating session locator codes associated with completed sessions is that session locator codes may be reused without risking making the previously shared documents available to unintended parties. This allows a larger number of sessions to be served over the lifetime of a server device 210 while keeping the length of the session locator code small, such as four or five alphanumeric characters, to allow the session locator codes to be manually shared and entered.

From terminal J (FIG. 3G), the method 300 proceeds to block 374, where a user interface engine 202 of a client device receives a request to exit a document sharing session, the request including a session locator code. At block 376, a locator code exchange engine 204 of the client device transmits the exit request to a server device 210. As illustrated, the assumption is made that the client device previously at least performed the set of method steps 304 discussed above to join the session. If not, the server device 210 may ignore the exit request, or may transmit an indication to the client device that the exit request is not valid. Next, at block 378, a session locator code distribution engine 212 of the server device 210 stores a record of the exit request, and associates the record of the exit request with the session locator code. In some embodiments, the record of the exit request and the association between the exit request and the session locator code are stored in the session locator code data store 215 of the server device 210.

The method 300 then proceeds to block 380, where the session locator code distribution engine 212 determines whether a count of exit requests associated with the session locator code indicates that all client devices have exited the session. In other words, the session locator code distribution engine 212 may query the session locator code data store 215 for a count of session joining requests as well as a count of session exit requests, and may determine whether all client devices have exited the session by comparing the two counts. The determination may show that all client devices have exited the session when the count of session joining requests is equal to the count of session exit requests. In another embodiment, the determination may show that all client devices have exited the session when the count of session exit requests is greater than the count of session joining requests (to account for the initiating client device, which may not have caused a record of a session joining request to be generated, but may nevertheless be part of the session).

At decision block 382, a test is performed based on the determination whether all client devices have exited the session. If the answer to the test at decision block 382 is NO, then the method 300 returns to terminal J until the next exit request is received. Otherwise, if the answer to the test at decision block 382 is YES, the method 300 proceeds to block 384, where a document distribution engine 216 of the server device 210 deletes any documents stored in a document data store 208 of the server device 210 associated with the session locator code. In an embodiment wherein the document data store 208 only stores a single copy of documents that are duplicated between sessions, the document distribution engine 216 may delete the documents upon determining that the present session is the last remaining session referencing the document. Next, at block 386, the session locator code distribution engine 212 stores an indication in a session locator code data store 215 that the session locator code is no longer in use. This indication allows the session locator code to be reused for subsequent sessions. In some embodiments, the indication may record a date/time value indicating when the session locator code was no longer in use, so that it may be held out of use for a predetermined amount of time to prevent inadvertent collisions that may occur if the session locator code was immediately reissued. The method 300 then proceeds to a continuation terminal (“terminal K”). From terminal K (FIG. 3A), the method 300 proceeds to an end block and terminates.

FIG. 4 illustrates an exemplary embodiment of a procedure 316 in which a session locator code distribution engine 212 generates a session locator code and stores a record of the session locator code generation in a session locator code data store 215, according to various aspects of the present disclosure. The procedure 316 was briefly discussed above in the context of method 300 in FIG. 3B. As discussed above, this procedure 316 is merely exemplary, and any suitable procedure for generating session locator codes may be used.

In block 402, a session locator code distribution engine 212 receives a request for a session locator code from a requesting device. Next, at block 404, the session locator code distribution engine 212 chooses a session locator code not currently in use. In one embodiment, a set of all possible session locator codes may be stored in a session locator code data store 215. This stored set of session locator codes may include indications of which of the set of all possible session locator codes are currently assigned. The session locator code distribution engine 212 may choose a session locator code from the stored set of session locator codes using any suitable method, such as picking a random entry in the session locator code data store, performing a round-robin selection from a predetermined list, and/or the like. In another embodiment, the session locator code distribution engine 212 may also randomly generate a session locator code by randomly selecting each alphanumeric digit, and may then query the session locator code data store 215 to determine if the resulting code is currently in use.

Next, at block 406, the session locator code distribution engine 212 compares the selected session locator code to a stop list of forbidden locator codes. The stop list of forbidden locator codes contains locator codes that, for one reason or another, would be inappropriate. For example, the stop list may include locator codes that, if displayed on a user interface, would form an obscene or profane word, or that could be interpreted as such. In some embodiments, contents of stop list may be generated by a system administrator. In some embodiments, the stop list may be dynamically altered based on session locator codes that are already in use. For example, in one embodiment, the stop list may be edited to include all session locator codes that would be only one character different from an already issued session locator code. This will help prevent issuing session locator codes that are only different by one character, which may be easily confused during manual code entry. In another exemplary embodiment, the stop list may be edited to include session locator codes with similar characters, such as session locator codes in which O (capital letter “O”) is replaced with 0 (the number zero), and/or the like, which could also be easily confused. In some embodiments, the use of a stop list for these codes is unnecessary, particularly if a session locator code is selected from a stored set of all possible session locator codes, as forbidden locator codes may simply be left out of the set of possible session locator codes.

At decision block 408, a test is performed to determine whether the selected session locator code is acceptable. If the answer to the test at decision block 408 is NO, then the procedure 316 returns to block 404, where another session locator code is chosen. If the answer to the test at decision block 408 is YES, then the procedure 316 proceeds to block 410, where the session locator code distribution engine 212 marks the session locator code as being in use. In some embodiments, this marking may occur within the session locator code data store. In some embodiments, the marking may include adding session locator codes one character different from the selected locator code to the stop list. Finally, at block 412, the session locator code distribution engine 212 transmits the selected session locator code to the requesting device to complete the procedure.

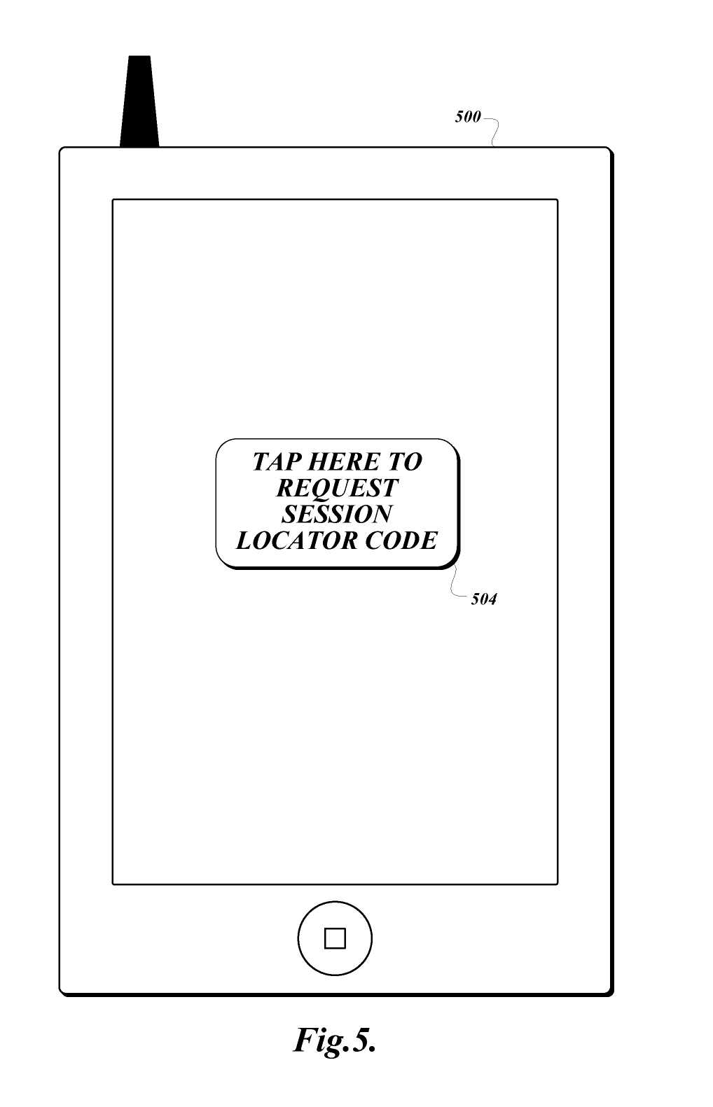

FIG. 5 illustrates an exemplary embodiment of a client device 500 such as a smart phone and/or the like presenting an interface for requesting a session locator code, according to various aspects of the present disclosure. The illustrated interface is quite simple, and helps to show the ease of use of embodiments of the present disclosure. The illustrated interface simply includes a code request interface button 504. Activating the code request interface button 504 is sufficient to begin the actions discussed above with respect to block 310 (FIG. 3B).

FIG. 6 illustrates a client device 500 presenting an exemplary interface for presenting a received session locator code to a requesting user, according to various aspects of the present disclosure. The illustrated interface includes one or more code character displays 602 and a data exchange interface button 504. Each code character display is sized as large as possible on a display of the client device 500, and includes both the code character itself (e.g., “X”, “0”, “F”, or “B”) and a phonetic alphabet version of the code character (e.g., “x-ray,” “zero,” “foxtrot,” or “bravo”). The size of the code character display may aid in character recognition, and the phonetic alphabet version of the code character may aid in reducing confusion between similar characters. For example, the second character of the displayed session locator code could be a zero character or a capital letter “O” character, but the phonetic alphabet version of the code character clearly disambiguates between the two. The exemplary interface illustrated in FIG. 6 is one example of an interface suitable for presentation in block 322 (FIG. 3B), and activation of the data exchange interface button 604 may cause the method 300 to proceed further, such as to terminal E (FIG. 3D).

FIG. 7 illustrates a client device 502 presenting an exemplary interface for receiving manual entry of a session locator code obtained by a different client device 500, according to various aspects of the present disclosure. The illustrated interface includes one or more code input display areas 702. As illustrated, two code input display areas 702 contain characters already entered by a user of the client device 502, and two code input display areas 704 are blank. Similar large spaces and phonetic alphabet versions of entered characters are provided in this exemplary interface to aid in reducing erroneous submissions. The blank code input display areas 704 may help indicate to the user how many characters are present in the session locator code. In some embodiments, the blank code input display areas 704 may not be presented.

The illustrated interface also includes a simplified keyboard display 706. Compared to a normal keyboard display as would be known to one of ordinary skill in the art, the simplified keyboard display 706 only displays keys that represent characters that may possibly be part of a session locator code, and a backspace/delete key. This reduces the effort necessary in finding the proper keys, and further reduces the probability of erroneous submissions. The illustrated interface also includes a cancel interface button 708 and a submit code interface button 710. Activating the cancel interface button 708 may simply cause any method 300 currently being performed by the client device 502 to cease. Activating the submit code interface button 710 may, for example, cause the method 300 to proceed from block 324 to block 326 (FIG. 3C).

FIG. 8 illustrates a client device 502 presenting an exemplary interface for exchanging documents according to various aspects of the present disclosure. In some embodiments, the client device 502 may be a downloading client device as discussed in FIGS. 3E-3F, and/or may have previously acted as an initiating client device as discussed in FIG. 3B. The illustrated interface includes an outgoing document display 802 and an incoming document display 808. The outgoing document display 802 includes a list of documents identified by a document management engine 206 of the client device 502 as being suitable for upload, as discussed above with respect to blocks 338 and 340 of FIG. 3D. As illustrated, the outgoing document display 802 includes an add document interface button 804 and an activated add document interface button 806. In some embodiments, the activated add document interface button 806 may indicate that a selection of the associated document was received by the user interface engine 202 of the client device 502, and that the associated document was selected and transmitted to the server device 210, as described in blocks 342 and 344 of FIG. 3D.

The incoming document display 808 includes a list of documents associated with the session locator code that are available for download, as discussed above with respect to block 364 of FIG. 3F. As illustrated, the incoming document display 808 includes one or more retrieve document interface buttons 810 and one or more activated retrieve document interface buttons 812, 814. In some embodiments, the activated retrieve document interface button may indicate that a selection was received by the user interface engine 202 of the client device 502, and that the associated document was selected and downloaded from the server device 210, as described in blocks 366-372 of FIG. 3F. In some embodiments, the retrieve document interface button 810 may indicate that the associated document is contained in the retrieved document list, but has not yet been downloaded. In other embodiments, the retrieve document interface button 810 may indicate that the associated document has been downloaded, but has not been permanently stored in the document data store 208 of the client device 502.

The illustrated interface also includes a participant count display 816. Even if any client device that obtains the session locator code is able to join the session, a session organizer may still wish to monitor the number of users or devices accessing the meeting, to determine if any unexpected users or devices have connected, or for other reasons. Accordingly, the participant count display 816 is provided, which reflects the current difference between the number of session joining request records and the number of exit request records associated with the given session locator code that are stored by the server device 210.

The illustrated interface also includes a exit interface button 820. In some embodiments, activation of the exit interface button 820 may cause the method 300 as being performed by the client device 502 to proceed to block 374 (FIG. 3G).

It is also notable that, in the illustrated embodiment, the incoming document display 808 does not include any documents that were uploaded by the client device 502, such as the “sales presentation for July 31 meeting” document. In other embodiments, the documents uploaded by the client device 502 would also appear in the incoming document display 808.

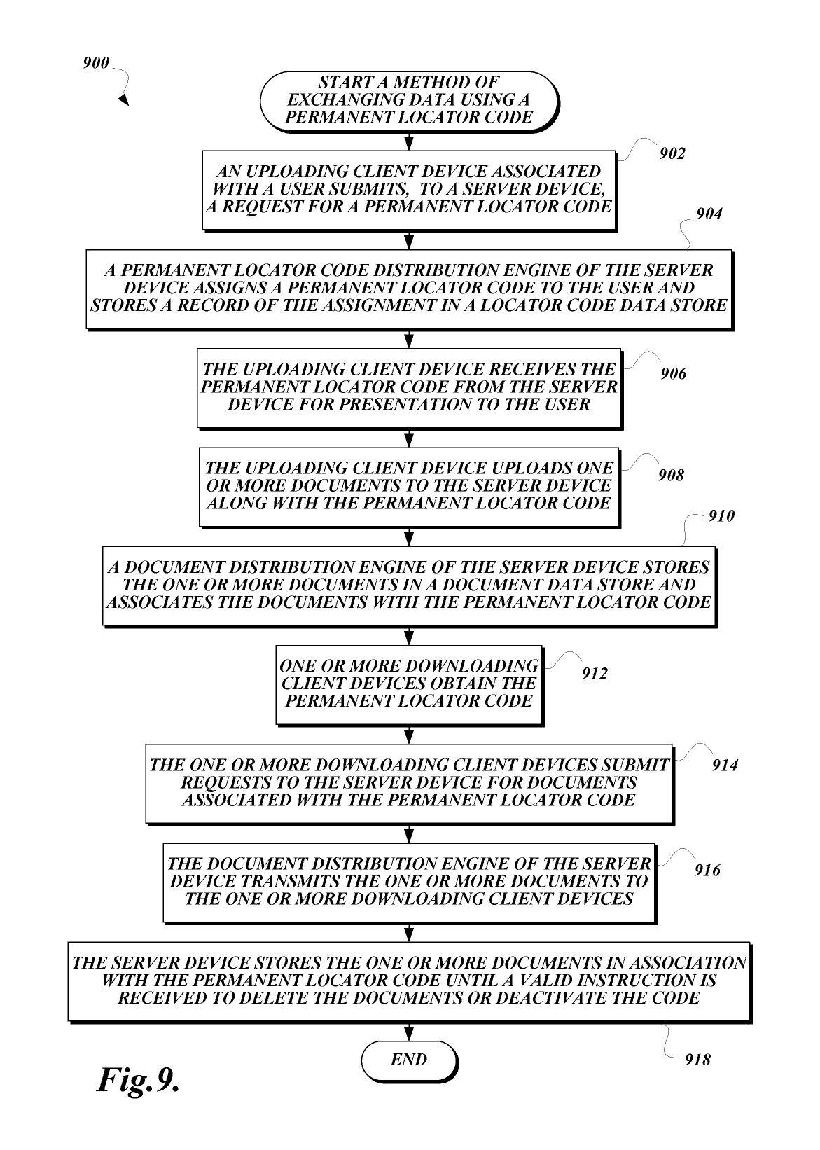

FIG. 9 illustrates one embodiment of a method 900 of exchanging data using a permanent locator code according to various aspects of the present disclosure. As mentioned above, the exchanging of data using permanent locator codes may be similar to the exchanging of data using session locator codes, with the exception that permanent locator codes continue to remain assigned even if no client devices are currently using the locator code to obtain data. This may allow, for example, a company to use a permanent locator code for one-way distribution of advertising information to customers. One benefit of using this system for potential customers who are using client devices is that they may obtain advertising information from companies only once they explicitly ask for it. As the potential customers must explicitly request the information by entering an obtained permanent locator code, the potential customers are the ones controlling the flow of information and may therefore be able to more effectively shield themselves from the torrent of unsolicited commercial advertising currently prevalent in online communications. One benefit of using this system for companies wishing to advertise to potential customers is that more potential customers may be willing to request and view the information if they know that they will be able to stop the flow of information at any time, and therefore the number of potential customers obtaining the information through the system may be higher than it would otherwise be.

From a start block, the method 900 proceeds to block 902, where an uploading client device associated with a user submits, to a server device 210, a request for a permanent locator code. In some embodiments, the user may wish to select a particular word or phrase to use a permanent locator code, such as a brand name, a trademarked word, an easy-to-remember pass phrase, a famous telephone number, an alphanumeric portion of a domain name, and/or the like. In some embodiments, the user may wish to have a permanent locator code (or a portion thereof) automatically generated by the server device 210, in which case the server device 210 may generate the permanent locator code via any suitable technique, such as the locator code generation techniques described above. In some embodiments, a permanent locator code may be any string of characters. In one particular embodiment, a permanent locator code is made up of alphanumeric characters, and may be case-insensitive. Limiting permanent locator codes to case-insensitive alphanumeric character strings may simplify manual permanent locator code entry on a client device, and may also simplify the server-side processing.

Next, at block 904, a permanent locator code distribution engine 213 of the server device 210 assigns a permanent locator code to the user and stores a record of the assignment in a locator code data store, such as permanent locator code data store 214. As the permanent locator code is intended to be valid regardless of whether any client devices are currently sharing documents using the permanent locator code, the permanent locator code is associated with the requesting user as opposed to the uploading client device.

In some embodiments, the permanent locator code distribution engine 213 may perform various checks before allowing the assignment to take place. For example, the permanent locator code distribution engine 213 may check to see if the requested permanent locator code has previously been assigned. As another example, the permanent locator code distribution engine 213 may check to see that the requested permanent locator code is shorter than a maximum length, contains any forbidden characters, contains any forbidden terms present on a stop list, and/or the like. The method 900 then proceeds to block 906, where the uploading client device receives the permanent locator code from the server device 210 for presentation to the user. In many cases, the permanent locator code will be identical to the requested permanent locator code. In some embodiments, the permanent locator code distribution engine 213 may assign a different permanent locator code than the requested permanent locator code in certain situations, such as, for example, if the requested permanent locator code had already been assigned. The user may inspect the presented permanent locator code to verify that it is acceptable.

Next, at block 908, the uploading client device uploads one or more documents to the server device 210 along with the permanent locator code. In one embodiment, the uploading client device may be similar to the intended downloading client devices and may be interacting with the server device 210 using a custom application. However, in other embodiments, the uploading client device may be a desktop computer or other type of computing device executing a standard web browser. In such embodiments, the uploading client device may connect to a web interface presented by one or more components of the server device 210 in order to conduct the actions described herein. Accordingly, when uploading one or more documents to the server device 210, the uploading client device may choose any document stored on the uploading client device for upload. Alternatively, the uploading client device may access a web interface presented by the server device 210 to create data objects, such as business cards, coupons, and/or the like, from a template provided by the interface.

At block 910, a document distribution engine 216 of the server device 210 stores the one or more documents in a document data store 208 and associates the documents with the permanent locator code. In some embodiments, the document distribution engine 216 may check that the permanent locator code is valid prior to storage, and/or may check that the user that uploaded the one or more documents has adequate permission with respect to the permanent locator code to store documents associated with the specified permanent locator code. In embodiments where the user is logged in to a web service, the permanent locator code may have already been associated with the login, and so the permanent locator code may not be transmitted again along with the one or more documents. In some embodiments, the association between the documents and the permanent locator code is stored in the document data store 208.

The method 900 then proceeds to block 912, where one or more downloading client devices obtain the permanent locator code. The downloading client devices may obtain the permanent locator code by any suitable technique, including the techniques described above such as manual viewing and entry, near-field communication, bar code or QR-code scanning, and/or the like. Next, at block 914, the one or more downloading client devices submit requests to the server device 210 for documents associated with the permanent locator code. At block 916, the document distribution engine 216 of the server device 210 transmits the one or more documents to the one or more downloading client devices.

From the perspective of the one or more downloading client devices, the actions performed in blocks 912-916 may be similar to the related actions performed with respect to a session locator code, with the exception of the lack of document uploading functionality. In some embodiments, the method 900 may include functionality similar to that discussed above with regard to first sending a list of documents to a downloading client device, and then transmitting particular documents to the downloading client device in response to receipt of a selection of documents from the list. Likewise, the interface presented by the downloading client device may be similar to the interface illustrated in FIG. 8, but for the absence of the documents to be uploaded and the display of a number of participants in the session.

From the perspective of the server device 210, the actions performed in blocks 912-916 may be similar to the related actions performed with respect to a session locator code, but further functionality may be removed for efficiency and/or privacy concerns. For example, since the permanent locator code will remain assigned to the user regardless of the number of client devices using it, the server device 210 may not store records of client devices and/or users that request documents associated with the permanent locator code. Similarly, the server device 210 may also not process or store records of exit requests.

At block 918, the server device 210 continues to store the one or more documents in association with the permanent locator code until a valid instruction is received to delete the documents or deactivate the code. In some embodiments, valid instructions may be transmitted only by the user who originally requested the permanent locator code, or by another user authorized by the requesting user to maintain the permanent locator code. In such embodiments, the server device 210 may validate the instructions by checking a password and/or user identity of the requesting user, and comparing it to a record of one or more users authorized to submit the instructions. Upon receipt of a valid instruction to delete the documents, the document distribution engine 216 may delete the documents from the document data store 218. Upon receipt of a valid instruction to deactivate the permanent locator code, the permanent locator code distribution engine 213 may remove the record of the assignment from the permanent locator code data store 214, thereby freeing up the permanent locator code for reassignment to another user. The permanent locator code distribution engine 213 may also instruct the document distribution engine 216 to delete all documents associated with the deactivated permanent locator code.

The method 900 then proceeds to an end block and terminates.

In general, the word “engine” (used interchangeably with the word application or module), as used herein, refers to logic embodied in hardware or software instructions, which can be written in a programming language, such as C, C++, COBOL, JAVA™, PHP, Perl, HTML, CSS, JavaScript, VBScript, ASPX, Microsoft .NET™, and/or the like. An engine may be compiled into executable programs or written in interpreted programming languages. Software engines or applications may be callable from other engines or from themselves. Generally, the engines or applications described herein refer to logical modules that can be merged with other engines or applications, or can be divided into sub-engines. The engines or applications can be stored in any type of computer-readable medium or computer storage device and be stored on and executed by one or more general purpose computers, thus creating a special purpose computer configured to provide the engine or application.

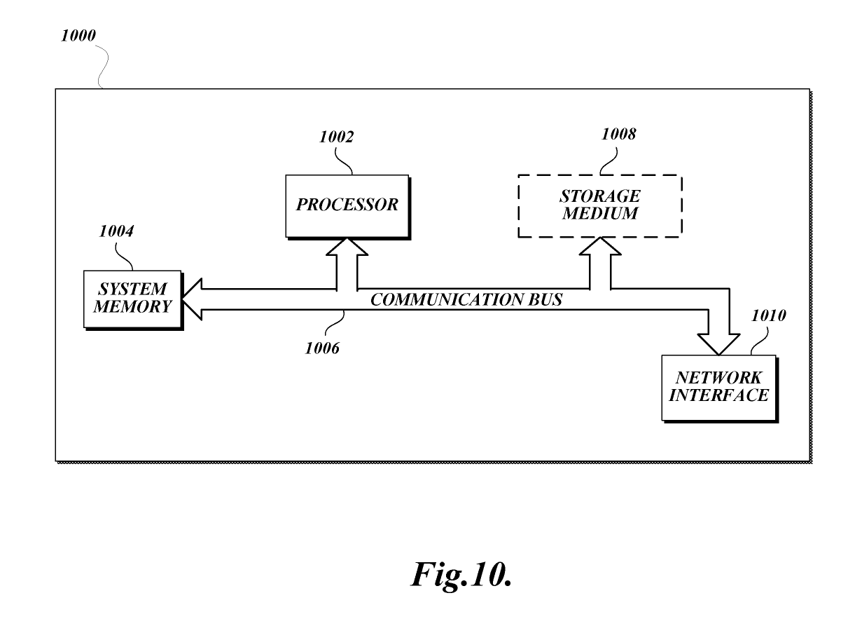

FIG. 10 illustrates aspects of an exemplary computing device 1000 appropriate for use with embodiments of the present disclosure. While FIG. 10 is described with reference to a computing device that is implemented as a device on a network, the description below is applicable to servers, personal computers, mobile phones, smart phones, and other devices that may be used to implement portions of embodiments of the present disclosure. Moreover, those of ordinary skill in the art and others will recognize that the computing device 1000 may be any one of any number of currently available or yet to be developed devices.

In its most basic configuration, the computing device 1000 includes at least one processor 1002 and a system memory 1004 connected by a communication bus 1006. Depending on the exact configuration and type of device, the system memory 1004 may be volatile or nonvolatile memory, such as read only memory (“ROM”), random access memory (“RAM”), EEPROM, flash memory, or similar memory technology. Those of ordinary skill in the art and others will recognize that system memory 1004 typically stores data and/or program modules that are immediately accessible to and/or currently being operated on by the processor 1002. In this regard, the processor 1002 may serve as a computational center of the computing device 1000 by supporting the execution of instructions.

As further illustrated in FIG. 10, the computing device 1000 may include a network interface 1010 comprising one or more components for communicating with other devices over a network. Embodiments of the present disclosure may access basic services that utilize the network interface 1010 to perform communications using common network protocols. The network interface 1010 may also include a wireless network interface configured to communicate via one or more wireless communication protocols.

In the exemplary embodiment depicted in FIG. 10, the computing device 1000 also includes a storage medium 1008. However, services may be accessed using a computing device that does not include means for persisting data to a local storage medium. Therefore, the storage medium 1008 depicted in FIG. 10 is represented with a dashed line to indicate that the storage medium 1008 is optional. In any event, the storage medium 1008 may be volatile or nonvolatile, removable or nonremovable, implemented using any technology capable of storing information such as, but not limited to, a hard drive, solid state drive, CD ROM, DVD, or other disk storage, magnetic cassettes, magnetic tape, magnetic disk storage, and/or the like.

As understood by one of ordinary skill in the art, a “data store” as described herein may be any suitable device configured to store data for access by a computing device. One example of a data store is a highly reliable, high-speed relational database management system (DBMS) executing on one or more computing devices and accessible over a high-speed packet switched network. However, any other suitable storage technique and/or device capable of quickly and reliably providing the stored data in response to queries may be used, and the computing device may be accessible locally instead of over a network, or may be accessible over some other type of suitable network or provided as a cloud-based service. A data store may also include data stored in an organized manner on a storage medium 1008.

As used herein, the term “computer-readable medium” includes volatile and non-volatile and removable and non-removable media implemented in any method or technology capable of storing information, such as computer readable instructions, data structures, program modules, or other data. In this regard, the system memory 1004 and storage medium 1008 depicted in FIG. 10 are merely examples of computer-readable media.

Suitable implementations of computing devices that include a processor 1002, system memory 1004, communication bus 1006, storage medium 1008, and network interface 1010 are known and commercially available. For ease of illustration and because it is not important for an understanding of the claimed subject matter, FIG. 10 does not show some of the typical components of many computing devices. In this regard, the computing device 1000 may include input devices, such as a keyboard, keypad, mouse, microphone, touch input device, touch screen, and/or. Similarly, the computing device 1000 may also include output devices such as a display, speakers, printer, etc. Since these devices are well known in the art, they are not illustrated or described further herein.

While illustrative embodiments have been illustrated and described, it will be appreciated that various changes can be made therein without departing from the spirit and scope of the invention.

The embodiments of the invention in which an exclusive property or privilege is claimed are defined as follows:

1. A computer-implemented method of exchanging data, the method comprising:
receiving, by a first device, a locator code;
uploading, by at least the first device, one or more data objects to a server device to be associated with the locator code; and
retrieving, by at least a second device, the one or more data objects from the server device by using the locator code.

2. The method of claim 1, further comprising requesting generation of a locator code; wherein the locator code received by the first device was generated by the server device in response to the request.

3. The method of claim 1, further comprising presenting, by the first device, the locator code for use by one or more other devices.

4. The method of claim 3, wherein presenting the locator code includes presenting the locator code on a display of the first device for manual entry on one or more other devices.

5. The method of claim 3, wherein presenting the locator code includes presenting the locator code to one or more other devices via near field communication.

6. The method of claim 3, wherein presenting the locator code includes presenting a visual representation of the locator code on a display of the first device for scanning by one or more other devices.

7. The method of claim 1, further comprising receiving, by the first device, a selection of one or more data objects in a document data store of the first device for upload.

8. The method of claim 1, further comprising:
receiving, by at least the second device, a list of data objects associated with the locator code; and
receiving, by the second device, a selection of one or more data objects from the list of data objects.

9. The method of claim 1, wherein the locator code is a session locator code.

10. The method of claim 9, further comprising transmitting, by the second device, a request to exit a session associated with the session locator code.

11. The method of claim 9, further comprising uploading, by at least the second device, one or more data objects to be associated with the locator code.

12. A computer-implemented method for managing a locator code, the method comprising:
receiving a request from a requesting device for a new locator code;
assigning a locator code not currently in use as the new locator code;
transmitting the new locator code to the requesting device;
receiving one or more data objects to be associated with the new locator code;
storing the one or more data objects in a document data store; and
associating the stored data objects with the new locator code.

13. The method of claim 12, further comprising:
comparing the new locator code with a set of forbidden locator codes; and
in response to determining that the new locator code is contained within the set of forbidden locator codes, randomly generating a replacement locator code.

14. The method of claim 12, wherein the new locator code is a session locator code.

15. The method of claim 14, further comprising:
receiving a request from a second requesting device for data objects associated with the new locator code; and
storing a record associating the second requesting device with the new locator code.

16. The method of claim 14, further comprising:
receiving a request for a second new locator code from a second requesting device;
selecting a locator code not currently in use;
comparing the selected locator code to the new locator code;
assigning a replacement locator code as the second new locator code in response to determining that the selected locator code is the same as the new locator code or is different by only one character;
assigning the selected locator code as the second new locator code in response to determining that the second new locator code is different from the new locator code by more than one character; and
transmitting the second new locator code to the second requesting device.

17. The method of claim 14, further comprising:
receiving a request from an exiting device to exit a session associated with the new locator code; and
deleting a record associating the exiting device with the new locator code.

18. The method of claim 17, further comprising, in response to detecting that no devices are associated with the new locator code, deleting one or more documents that are associated with the new locator code and stored in the document data store.

19. The method of claim 12, further comprising sending data objects associated with a locator code to a client device in response to receiving a request from the client device for the data objects.

20. The method of claim 19, wherein the data objects sent to the client device do not include data objects uploaded by the client device.

21. The method of claim 12, wherein the new locator code is a permanent locator code.

22. The method of claim 21, wherein the request for a new locator code includes a requested locator code; and wherein assigning a locator code not currently in use as the new locator code includes assigning the requested locator code as the new locator code.
